(19) United States
(12) Patent Application Publication
(10) Pub. No.: US 2015/0303719 A1
(43) Pub. Date: Oct. 22, 2015

(54) Battery Combined System

(71) Applicant: HITACHI, LTD., Tokyo (JP)

(72) Inventors: Chiaki TAKAHASHI, Hitachi-shi (JP); Kenji TAKEDA, Hitachi-shi (JP); Takeshi INOUE, Hitachi-shi (JP)

(73) Assignee: Hitachi, Ltd., Chiyoda-ku, Tokyo (JP)

(21) Appl. No.: 14/648,505

(22) PCT Filed: Jan. 30, 2013
(86) PCT No.: PCT/JP2013/051948

§ 371 Date: May 29, 2015

(51) Int. Cl. H02J 7/00

(52) U.S. Cl. CPC H02J 7/0021

(57) ABSTRACT

Provided is a battery combined system in which a system operation rate is improved by reducing, in comparison with a conventional method, a frequency at which an SOC of a power type battery reaches an upper limit or a lower limit. The battery combined system according to the present invention is a battery combined system in which a capacity type battery and a power type battery having a higher output value with respect to a capacity (output/capacity) than that of the capacity type battery are connected in parallel. The battery combined system changes a threshold value to distribute charge/discharge power to the power type battery or the capacity type battery in the case where the charge/discharge power is equal to or less than maximum charge power and equal to or larger than maximum discharge power of the capacity type power.

### TECHNICAL FIELD

The present invention relates to a battery combined system in which multiple batteries having different characteristics are combined.

### BACKGROUND ART

Currently, power to be supplied to the society is generated by burning fossil fuels, such as oil and coal, to generate high temperature/high pressure steam, and thereby rotating a steam turbine. However, recently, a power generation system using natural energy (such as solar power generation and wind power generation) is increasing in terms of environmental considerations.

There is a system for smoothing power to be output to a power system by providing a large scale battery system connected to multiple storage batteries in multiple series parallel with respect to the power generation system using natural energy. However, since a charge/discharge power pattern of a battery of this battery system varies depending on installation environment (a wind speed and a solar radiation amount), necessary output (W) and capacity (Wh) specifications of this battery system vary among cases.

In the case where a ratio of the output (W) and the capacity (Wh) is not corresponding to cell characteristics, either of the output or the capacity has a mismatch. As a result, a system that increases an unnecessary battery is designed. Such design increases cost, and investment recovery is delayed. Accordingly, it becomes an issue when a battery system is introduced.

To solve this issue, PTL 1 discloses a battery combined system which provides a system having an output/capacity ratio appropriate to an application, by parallelly connecting a capacity type battery group with a large capacity and low output (hereinafter referred to as a capacity type battery) and a power type battery group having a higher output value with respect to a capacity (output/capacity) than that of the capacity type battery (hereinafter referred to as a power type battery).

On the other hand, a battery system including both of the capacity type battery and the power type battery according to PTL 1 needs power distribution control for distributing overall charge/discharge power, which will be input to a battery combined system, to the capacity type battery and the power type battery in operation of the battery combined system.

For example, PTL 2 discloses control in which, after an arbitral fixed value is set, a current equal to or less than the set value is input to a capacity type battery and current equal to or larger than the set value is input to a power type battery or both of the capacity type battery and the power type battery.

### CITATION LIST

### Patent Literature

PTL 1: JP 2007-135355 A
PTL 2: JP 2000-295784 A

### SUMMARY OF INVENTION

### Technical Problem

However, in the method for distributing power with fixed threshold value according to PTL 2, a state of charge (SOC) of a power type battery easily reaches an upper limit or a lower limit since a capacity of the power type battery is small.

If an SOC of the power type battery reaches the upper limit or the lower limit, there is a problem where a system operation rate is lowered since the power type battery cannot be charged or discharged.

In the present invention, in view of the above issue, a battery combined system is provided in which a system operation rate is improved by reducing a frequency at which an SOC of the power type battery reaches an upper limit or a lower limit in comparison with a conventional method.

### Solution to Problem

A battery combined system according to the present invention is a battery combined system in which a capacity type battery and a power type battery having a higher output value with respect to a capacity (output/capacity) than that of the capacity type battery are connected in parallel. In the case where charge/discharge power is equal to or less than maximum charge power and equal to or larger than maximum discharge power of the capacity type battery, the battery combined system changes a threshold value for distributing the charge/discharge power to the power type battery or the capacity type battery.

### Advantageous Effects of Invention

According to the present invention, by adjusting an SOC of a power type battery, a frequency at which the SOC reaches an upper limit or a lower limit is reduced, and therefore a frequency at which the power type battery cannot be charged or discharged is reduced. As a result, a system operation rate of a battery combined system can be improved.

### BRIEF DESCRIPTION OF DRAWINGS

FIG. 1 is a diagram illustrating a configuration of a battery combined system according to the present invention.

FIG. 2 is a flowchart illustrating a calculation procedure for an inverter power command value of a battery combined controller according to a first embodiment.

FIG. 3(a) is a diagram illustrating correlation between a first threshold value and a second threshold value in step S302 illustrated in FIG. 2. FIG. 3(b) is a diagram illustrating correlation between a first threshold value and a second threshold value in step S303 illustrated in FIG. 2.

FIG. 4(a) is a diagram illustrating time changes in charge/discharge power and an SOC_{P} in the case where a threshold value is not changed. FIG. 4(b) is a diagram illustrating time changes in the charge/discharge power and the SOC_{P} in the case where the first embodiment is applied.

FIG. 5 illustrates a block diagram of a battery combined controller 104 according to the first embodiment.

FIG. 6 is a flowchart illustrating a calculation procedure for an inverter power command value of a battery combined controller according to a second embodiment.

FIG. 7(a) is a diagram illustrating correlation between a first threshold value and a second threshold value in step S302 illustrated in FIG. 6. FIG. 7(b) is a diagram illustrating correlation between a first threshold value and a second threshold value in step S313 illustrated in FIG. 2.

FIG. 8 is a diagram illustrating time changes in charge/discharge power and an SOC_{P} in the case where the second embodiment is applied.

FIG. 9(a) is a diagram illustrating correlation between a first threshold value and a second threshold value in step S302 illustrated in FIG. 2. FIG. 9(b) is a diagram illustrating correlation between a first threshold value and a second threshold value in step S303 illustrated in FIG. 2.

FIG. 10 is a diagram illustrating time changes in charge/discharge power and an SOC_{P} in the case where a third embodiment is applied.

FIG. 11 is a flowchart illustrating a calculation procedure for an inverter power command value of a battery combined controller according to a fourth embodiment.

### DESCRIPTION OF EMBODIMENTS

### First Embodiment

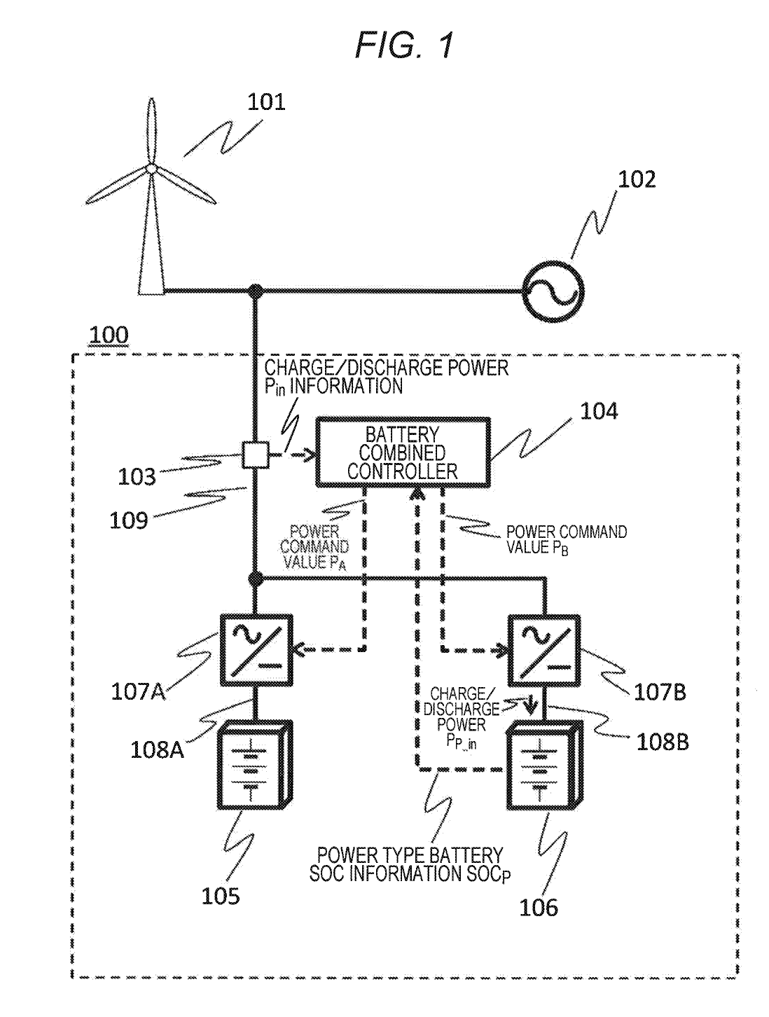

A battery combined system 100 will be described with reference to FIG. 1.

The battery combined system 100 includes an inverter 107A and an inverter 107B. A capacity type battery 105 including multiple batteries and a power type battery 106 including multiple batteries are respectively connected on DC line (108A and 108B) sides of each inverter. Also, each of the inverter 107A and the inverter 107B are parallelly connected each other on an AC line 109 side and connected to a power generation device 101 and a power system 102, which are located outside of the battery combined system 100. Also, a power measuring device 103 is provided on the AC line 109.

The power measuring device 103 has functions to measure charge/discharge power Pᵢₙ to be input to the battery combined system 100 and to transmit the measurement to a battery combined controller 104. In the charge/discharge power Pᵢₙ to be input to the battery combined system 100, and charge/discharge powers P_{E}_{_{—}}ᵢₙ and P_{P}_{_{—}}ᵢₙ to be respectively input to the capacity type battery 105 and the power type battery 106, a charge power value is defined as a positive value and a discharge power value is defined as a negative value. The power type battery 106 has a function to calculate an SOC_{P}, which is an SOC of the power type battery, based on the charge/discharge power P_{P}_{_{—}}ᵢₙ to be input to the power type battery 106 and information (such as a battery voltage Vₚ and a battery temperature Tmpₚ) obtained from the power type battery 106. The power type battery 106 also has a function to transmit the calculation result to the battery combined controller 104.

The battery combined controller 104 obtains the charge/discharge power Pᵢₙ from the power measuring device 103 and the SOC_{P} information from the power type battery 106, and calculates a charge/discharge power command value P_{A} of the inverter 107A and a charge/discharge power command value P_{B} of the inverter 107B. A calculation method will be described in detail later.

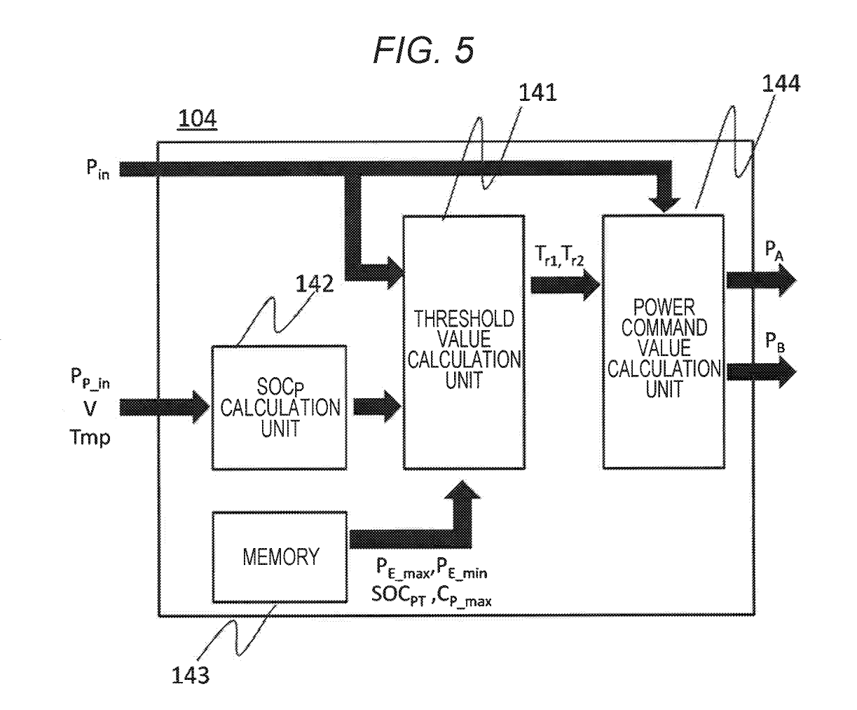

FIG. 5 is a diagram illustrating an inside of the battery combined controller 104 illustrated in FIG. 1. The battery combined controller 104 includes a threshold calculation unit 141 which calculates a first threshold value Tᵣ₁ and a second threshold value Tᵣ₂, an SOC_{P} calculation unit 142 which calculates the SOC_{P} of the power type battery 106, a memory 143 which stores information on, for example, maximum charge power PE_{—max} of the capacity type battery 105 and a full charge power capacity CP_{—max} of the power type battery, and a power command value calculation unit 144 which calculates charge/discharge power command values P_{A} and P_{B} for controlling respectively the inverter 107A and the inverter 107B.

First, the charge/discharge power P_{P}_{_{—}}ᵢₙ, the battery voltage V_{P}, and the battery temperature Tmp, which will be input to the power type battery 106, are input to the SOC_{P} calculation unit 142. The SOC_{P} calculation unit 142 then calculates the current SOC_{P} of the power type battery 106. As an example of the calculation method, a method using a current integration method will be described. In the power type battery 106, a charge/discharge current Iₚ_{_{—}}ᵢₙ to be input to the power type battery 106 is calculated by the formula (1) below using the battery voltage Vₚ and the charge/discharge power P_{P}_{_{—}}ᵢₙ.

$${I}_{P\_in} = \frac{{P}_{P\_in}}{{V}_{P}} \qquad ( 1 )$$

Herein, the charge/discharge current Iₚ_{_{—}}ᵢₙ may be obtained by placing a current sensor on the DC line 108B of the inverter 107B and measuring the current. Next, the SOC_{P}, which is an SOC of the power type battery, is calculated by the following formula based on the charge/discharge current Iₚ_{_{—}}ᵢₙ, an initial charging capacity C_{P0}, and the full charge power capacity C_{P}_{_{—}}ₘₐₓ of the power type battery.

$${SOC}_{P} = \frac{{C}_{P 0} + \int {1}_{P\_in} d t}{{C}_{P\_max}} \times 100 \qquad ( 2 )$$

Then, the charge/discharge power Pᵢₙ obtained from the current measuring device 103 and the SOC_{P} of the power type battery 106 are input to the threshold calculation unit 141. At this point, the maximum charge power P_{E}_{_{—}}ₘₐₓ, the maximum discharge power P_{E}_{_{—}}ₘᵢₙ, an SOC_{PT} which is a target SOC, and the full charge power capacity C_{P}_{_{—}}ₘₐₓ of the power type battery 106 are input from the memory 143 to the threshold calculation unit 141. Then, the first threshold value Tᵣ₁ and the second threshold value Tᵣ₂ are calculated after the calculation, which will be described later, in the threshold calculation unit 141. The calculation method will be described in detail later.

Finally, the first threshold value Tᵣ₁, the second threshold value Tᵣ₂, and the charge/discharge power Pᵢₙ are input to the power command calculation unit 144, and the power command values P_{A} and P_{B} are calculated in the power command calculation unit 144. Subsequently, these power command values P_{A} and P_{B} are output to the inverter 107A and 107B, respectively.

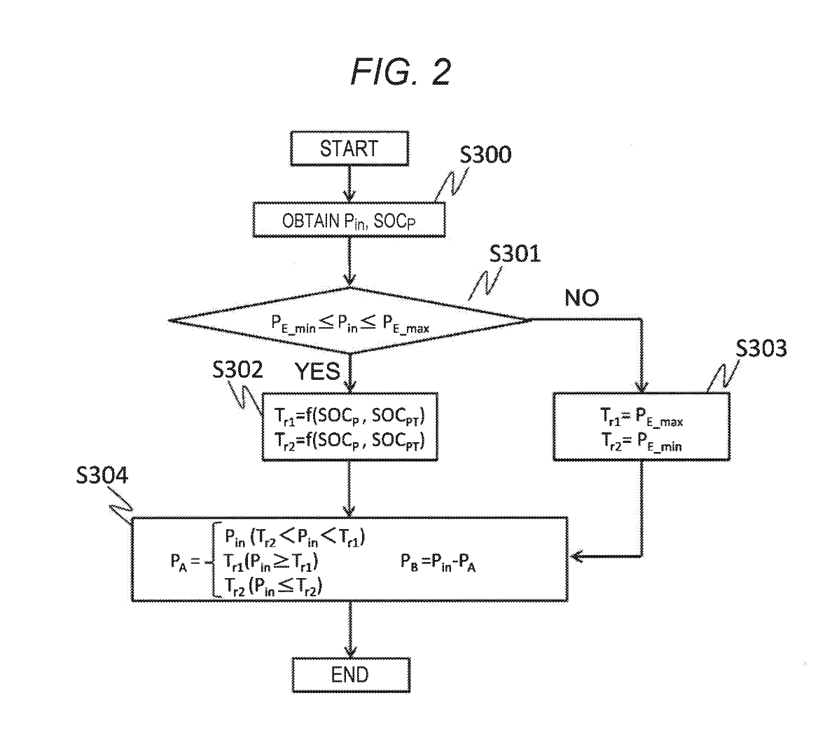

Next, the above calculation content will be described in detail with reference to FIG. 2. FIG. 2 is a flowchart illustrating a procedure for calculating the inverter power command values P_{A} and P_{B} of the battery combined controller 104.

First, in step S300, the threshold calculation unit 141 obtains each of the charge/discharge power Pᵢₙ and the power type battery SOC_{P}. Then, in step S301, it is determined whether the charge/discharge power Pᵢₙ is equal to or less than the maximum charge power P_{E}_{_{—}}ₘₐₓ and equal to or larger than maximum discharge power P_{E}_{_{—}}ₘᵢₙ of the capacity type battery 105.

The maximum charge power P_{E}_{_{—}}ₘₐₓ and the maximum discharge power P_{E}_{_{—}}ₘᵢₙ are values for controlling so as not to flow excessive current, which affects a lifetime of and cause heating to the capacity type battery 105, such as equal to or larger than 10C. The values are such as a continuous rated value of a battery and a maximum charge/discharge power value of a pulse within two seconds. Also, the values are stored in the memory 143 as described above.

The procedure proceeds to step S302 if it has been determined in step S301 that the charge/discharge power Pᵢₙ is equal to or less than the maximum charge power P_{E}_{_{—}}ₘₐₓ and equal to or larger than the maximum discharge power P_{E}_{_{—}}ₘᵢₙ.

Herein, the value equal to or larger than the maximum discharge power P_{E}_{_{—}}ₘᵢₙ is in the case of taking a charging side as a positive value. Therefore, in the case of taking an absolute value of the charge/discharge power Pᵢₙ under conditions in step S301, the absolute value is 0≦|Pᵢₙ|≦|P_{E}_{_{—}}ₘₐₓ| and 0≦|Pᵢₙ|≦|P_{E}_{_{—}}ₘᵢₙ|. Specifically, it means that an absolute value of the charge/discharge power Pᵢₙ is equal to or less than an absolute value of maximum charge power and equal to or less than an absolute value of maximum discharge power of the capacity type battery.

In step S302, the first threshold value Tᵣ₁ and the second threshold value Tᵣ₂ are set based on the SOC_{P}, which is an SOC of the power type battery 106, and a target SOC SOC_{PT}. In the case where the battery combined system 100 is used for smoothing power, preferably the power type battery 106 can be charged and discharged anytime.

In the embodiment, the target SOC SOC_{PT} of the power type battery 106 is described as a center value of an SOC usage range (for example, in the case where a lower limit value of the SOC usage range is 30% and an upper limit value of the SOC usage range is 80%, the target SOC SOC_{PT} is 55%). In the case of an application where it is considered that large power is often discharged like a UPS and rarely charged, the SOC_{PT} may be set to around 90% of the SOC usage range. As a result, the power type battery 106 can discharge large power for a longer period in comparison with a case where the SOC_{PT} is set as a center value of the SOC usage range.

As a calculation example of the first threshold value Tᵣ₁ and the second threshold value Tᵣ₂, a method using the battery voltage V_{P} and the full charging capacity C_{P}_{_{—}}ₘₐₓ of the power type battery and a proportional constant S set based on a control cycle, in addition to the SOC_{P} of the power type battery 106, will be described herein. The formula (1) below represents a case of SOC_{P}≧SOC_{PT} and the formula (2) below represents a case of SOC_{P}<SOC_{PT}.

$$\begin{matrix}{T}_{r 2} = \frac{( {SOC}_{P} - {SOC}_{PT} )}{100} \times {C}_{P\_max} \times {V}_{P} \times S + {P}_{E\_min} \\ ( {T}_{r 2} = 0 in the case of {T}_{r 2} \geq 0 ) & ( 1 ) \\ {T}_{r 1} = \frac{( {SOC}_{PT} - {SOC}_{P} )}{100} \times {C}_{P\_max} \times {V}_{P} \times S + {P}_{E\_max} \\ ( {T}_{r 1} = 0 in the case of {T}_{r 1} < 0 ) & ( 2 )\end{matrix}$$

Note that the first threshold value needs to satisfy Tᵣ₁=P_{E}_{_{—}}ₘₐₓ in the formula (1) since the capacity type battery 105 cannot discharge power exceeding the maximum charge power P_{E}_{_{—}}ₘₐₓ of the capacity type battery 105. Also, Tᵣ₂=0 is set in the case of Tᵣ₂≧0 in the formula (1) to prevent deviation from the target SOC_{PT} of the SOC_{P} by preventing charging by the power type battery 106 in the case of SOC_{P}≧SOC_{PT}.

For the same reason, the second threshold value needs to satisfy Tᵣ₂=P_{E}_{_{—}}ₘᵢₙ in the formula (2) since the capacity type battery 105 cannot discharge power exceeding the maximum discharge power P_{E}_{_{—}}ₘᵢₙ of the capacity type battery 105. Also, Tᵣ₁=0 is set in the case of Tᵣ₁<0 in the formula (2) to prevent deviation from the target SOC_{PT} of the SOC_{P} by preventing discharging by the power type battery 106 in the case of SOC_{P}<SOC_{PT}.

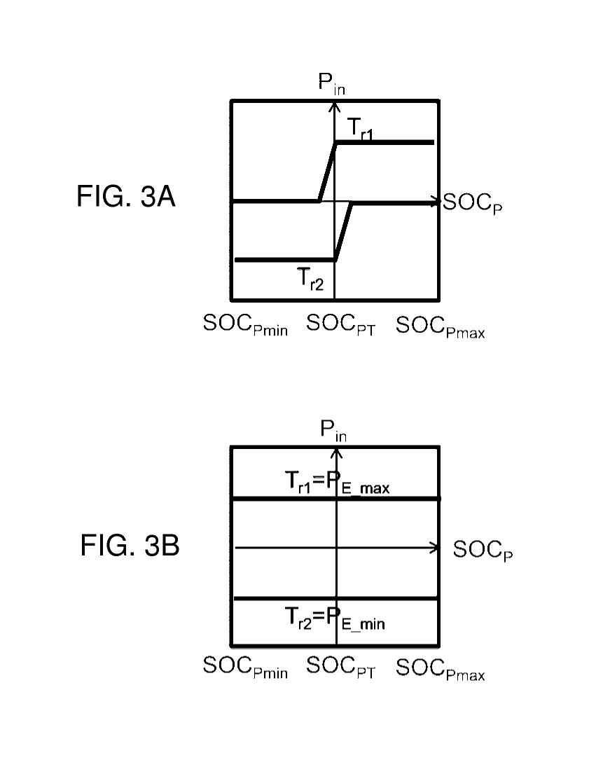

FIG. 3(a) is a diagram illustrating correlation between the SOC_{P} of the power type battery 106 and the first threshold value Tᵣ₁ and the second threshold value Tᵣ₂ based on the formulas (1) and (2) as described above.

When it is determined in step S301 that the charge/discharge power Pᵢₙ is equal to or less than the maximum charge power P_{E}_{_{—}}ₘₐₓ or equal to or larger than the maximum discharge power P_{E}_{_{—}}ₘᵢₙ, the procedure proceeds to step S302 to satisfy the condition in step S301.

In step S302, a control is performed so as to satisfy the conditions of the above-described formulas (1) and (2). In the case of proceeding to step S302, the first threshold value Tᵣ₁ and the second threshold value Tᵣ₂ are controlled as illustrated in FIG. 3(a).

On the other hand, when it is determined in step S301 that the charge/discharge power Pᵢₙ is larger than the maximum charge power P_{E}_{_{—}}ₘₐₓ or smaller than the maximum discharge power P_{E}_{_{—}}ₘᵢₙ, the condition of step S301 is not satisfied, and therefore the procedure proceeds to step S303.

In step S303, the first threshold value Tᵣ₁ is the maximum charge power P_{E}_{_{—}}ₘₐₓ of the capacity type battery 105, and the second threshold value Tᵣ₂ is the maximum discharge power P_{E}_{_{—}}ₘᵢₙ of the capacity type battery 105. As described above, in the case where a charging side is taken as a positive value, the charge/discharge power is equal to or larger than the maximum discharge power P_{E}_{_{—}}ₘᵢₙ. Therefore, a condition for proceeding from step S301 to Step S303 is that an absolute value of the charge/discharge power Pᵢₙ becomes |P_{E}_{_{—}}ₘₐₓ|<|Pᵢₙ| and |P_{E}_{_{—}}ₘᵢₙ|<|Pᵢₙ|.

Specifically, it means that the absolute value of the charge/discharge power Pᵢₙ is larger than an absolute value of maximum charge power of the capacity type battery, or the absolute value of the charge/discharge power Pᵢₙ is larger than an absolute value of maximum discharge power.

FIG. 3(b) illustrates correlation between the SOC_{P} of the power type battery 106 and the first threshold value Tᵣ₁ and the second threshold value Tᵣ₂ in step 303. Specifically, in the case where the procedure proceeds to step S303, the first threshold value Tᵣ₁ and the second threshold value Tᵣ₂ are controlled as illustrated in FIG. 3(b).

After the first threshold value Tᵣ₁ and the second threshold value Tᵣ₂ have been set in step S302 or step S303, the procedure proceeds to step S304. In step S304, the inverters 107A and 107B calculate the power command values P_{A} and P_{B}. The formulas (3) and (4) below are calculation formulas for the power command values P_{A} and P_{B}.

$$\begin{matrix}{P}_{A} = [ \begin{matrix}{P}_{in} ( {T}_{r 2} < {P}_{in} < {T}_{r 1} ) \\ {T}_{r 1} ( {P}_{in} \geq {T}_{r 1} ) \\ {T}_{r 2} ( {P}_{in} \leq {T}_{r 2} )\end{matrix} & ( 3 ) \\ {P}_{B} = {P}_{in} - {P}_{A} & ( 4 )\end{matrix}$$

The battery combined controller 104 calculates power command values P_{A} and P_{B} by using the flowchart in FIG. 2 and sends the power command values P_{A} and P_{B} to the inverter 107A and the inverter 107B. The inverter 107A and the inverter 107B receive the power command values P_{A} and P_{B} sent from the combined controller 104 and control charging and discharging by the capacity type battery 105 and the power type battery 106 based on the power command values P_{A} and P_{B}.

As described above, in the case of Pᵢₙ>P_{E}_{_{—}}ₘₐₓ and P_{E}_{_{—}}ₘᵢₙ>Pᵢₙ, the power type battery 106 forcibly covers charging and discharging in the embodiment. However, in the case of P_{E}_{_{—}}ₘₐₓ≧Pᵢₙ≧P_{E}_{_{—}}ₘᵢₙ, power can be flexibly distributed to the capacity type battery 105 and the power type battery 106 by the above-described control. Therefore, power can be equally distributed to the capacity type battery 105 and the power type battery 106, and a frequency at which the SOC of the power type battery 106 reaches an upper limit value or a lower limit value can be reduced. Also, the power type battery 106 is controlled so as to avoid a region where charging/discharging is not possible, and a battery combined system with an improved system operation can be provided.

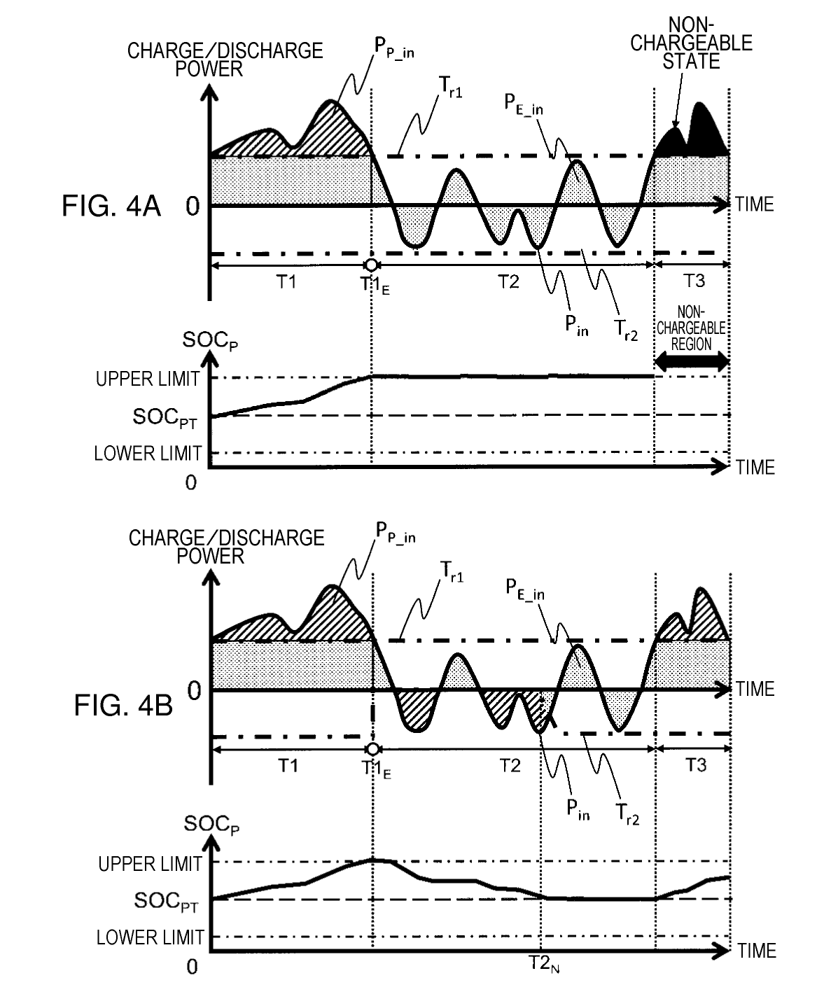

FIG. 4 (a) illustrates a time change in charge/discharge power and a time change in the SOC_{P} of the power type battery in the case where a threshold value is fixed. FIG. 4(b) illustrates a time change in charge/discharge power and a time change in the SOC_{P} of the power type battery in the case where a threshold value is changed by using a control according to the embodiment.

Time changes in the charge/discharge power Pᵢₙ to be input to the battery combined system 100 (a solid line in FIG. 4), the charge/discharge power P_{E}_{_{—}}ᵢₙ to be input to the capacity type battery 105, the charge/discharge power P_{P}_{_{—}}ᵢₙ to be input to the power type battery 106, the first threshold value Tᵣ₁, the second threshold value Tᵣ₂, and the power type battery SOC_{P} are indicated. In FIG. 4, diagonal line portions indicate the charge power (or discharge power) P_{P}_{_{—}}ᵢₙ to the power type battery 106, and hatched portions indicate the charge power (or discharge power) P_{E}_{_{—}}ᵢₙ to the capacity type battery 105. Therefore, the charge/discharge power Pᵢₙ is a total of P_{P}_{_{—}}ᵢₙ and P_{E}_{_{—}}ᵢₙ.

The first threshold value Tᵣ₁ and the second threshold value Tᵣ₂ are fixed by the control illustrated in FIG. 4(a) (see a dashed line portion in FIG. 4(a)). The SOC_{P} of the power type battery 106 reaches an upper limit SOC at a time T_{1E} in a section T1. In the following section T2, the charge/discharge power Pᵢₙ is smaller than the threshold value Tr1 and larger than the threshold value Tr2, and therefore charging and discharging are entirely performed by the capacity type battery 105. If the charge/discharge power Pᵢₙ again exceeds the threshold value Tᵣ₁ in a section T3, charging by the power type battery 106 is attempted. However, the SOC_{P} of the power type battery 106 has reached an upper limit SOC, and therefore the power type battery 106 cannot be charged (a blacked portion in the section T3). Therefore, in this period, not only power is wasted but also the power which has not been absorbed in the power system 102 might become noise.

On the other hand, FIG. 4 (b) illustrates a state in which the present invention is applied as described in the embodiment. In the case where the invention is applied as described in the embodiment, the SOC_{P} of the power type battery 106 has reached the upper limit SOC at an end T1_{E} of the section T1. Therefore, the second threshold value Tᵣ₂ is changed in the following section T2, and the power type battery 106 is controlled to be discharged. When the SOC_{P} of the power type battery reaches the target SOC_{PT} in the section T2 (when reaching T2_{N} in FIG. 4(b)), the threshold value T2 is controlled to be changed again. A period that the SOC_{P} of the power type battery 106 reaches the upper limit can be shortened by controlling as described above. Therefore, even if the charge/discharge power Pᵢₙ exceeds the threshold value Tᵣ₁ in the section T3, the power type battery 106 can be charged. As a result, there is no period where the power type battery 106 cannot be charged, and a system operation rate can be improved.

Although a battery system for smoothing power of the power generation device 101 has been described as an example in the first embodiment, the present invention can be applied to a building energy management system (BEMS), a home energy management system (HEMS), a stationary battery system using for a UPS, an electric vehicle, an onboard battery system for a hybrid vehicle or the like, a battery system for a construction machinery such as an EV construction machinery and a hybrid construction machinery, a hybrid railway vehicle, and a battery system for a railway vehicle such as a B-Chop.

Also, although power is distributed based on charge/discharge power in the first embodiment, charge/discharge current may be used instead of the charge/discharge power.

### Second Embodiment

A second embodiment will be described next.

An overall configuration of the second embodiment is similar to the overall configuration of the first embodiment illustrated in FIG. 1. The second embodiment differs from the first embodiment in that a first threshold value Tᵣ₁ and a second threshold value Tᵣ₂ are changed in the case of Pᵢₙ>P_{E}_{_{—}}ₘₐₓ and in the case of P_{E}_{_{—}}ₘᵢₙ>Pᵢₙ.

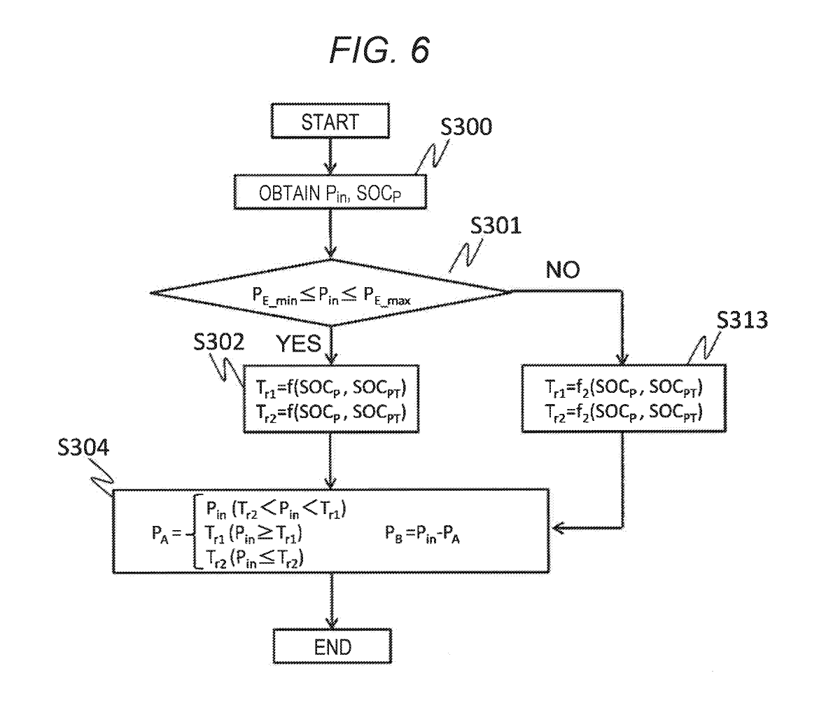

FIG. 6 is a flowchart illustrating a calculation procedure for inverter power command values P_{A} and P_{B} of a battery combined controller 104 according to the second embodiment. In the second embodiment, in step S313, the first threshold value Tᵣ₁ and the second threshold value Tr2 are variable depending on an SOC_{P} of a power type battery 106.

A calculation example of the first threshold value Tᵣ₁ and the second threshold value Tᵣ₂ in step S313 is indicated in formulas (5) and (6) by using the SOC_{P} of the power type battery 106, and upper and lower limits SOC_{Pmin} and SOC_{Pmax} of the SOC_{P}, and a constant α₁. Herein the SOC_{Pmin} is, for example, SOC_{PT-α}_{₁}; and the SOC_{Pmax} is, for example, preferably defined as SOC_{PT+α}_{₁}. By defining as above, a frequency at which an SOC of the power type battery is far deviated from a target SOC is reduced, and therefore a battery combined system capable of stable driving can be provided.

$$\begin{matrix}{T}_{r 2} = - \frac{{P}_{E\_min}}{{α}_{1}} ( {SOC}_{P} - {SOC}_{P\_max} ) \\ ( {T}_{r 2} = {P}_{E\_min} in the case of {SOC}_{P} \leq {SOC}_{P\_max} - α1 ) & ( 5 ) \\ {T}_{r 1} = - \frac{{P}_{E\_max}}{{α}_{1}} ( {SOC}_{P} - {SOC}_{P\_min} ) \\ ( {T}_{r 1} = {P}_{E\_max} in the case of {SOC}_{P} \geq {SOC}_{P\_min} + α1 ) & ( 6 )\end{matrix}$$

If the constant α₁ is too large, a use rate of the power type battery 106 becomes high, and a battery life might be shortened. Therefore, the constant value is preferably around 5 to 10%.

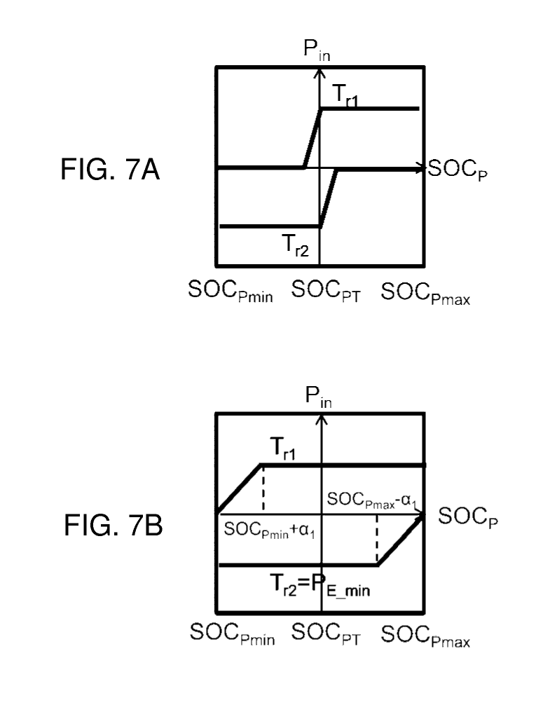

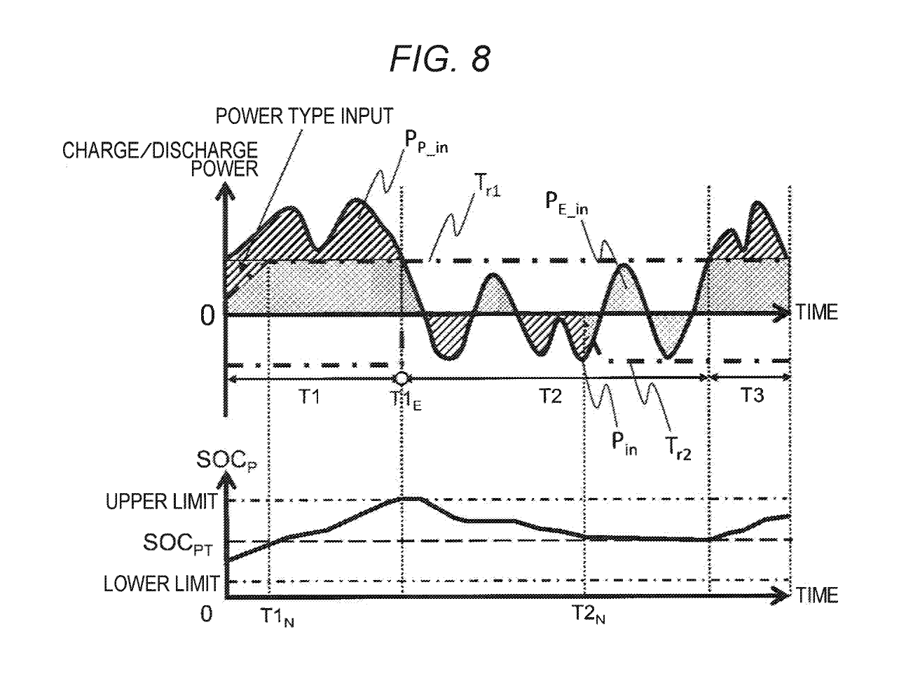

FIG. 7(a) is a diagram similar to FIG. 3(a). The constant α₁ applied in the embodiment is a value for determining a variation width of a threshold value. As illustrated in FIG. 7(b), in step 313, if the SOC_{P} of the power type battery reaches α₁% of each of an upper limit value and a lower limit value, absolute values of the first threshold value Tᵣ₁ and the second threshold value Tᵣ₂ are started to be lowered. FIG. 8 illustrates a time change in charge/discharge power and a time change in the SOC_{P} of the power type battery, in the case where a threshold value is changed by using a control according to the second embodiment. A different point from the first embodiment is that discharging by T₁ₙ is covered by the power type battery 106 by applying step S313 described above. The SOC_{P} of the power type battery 106 more frequently comes close to a target value by changing the first threshold value Tᵣ₁ and the second threshold value Tᵣ₂ in the case of Pᵢₙ>P_{E}_{_{—}}ₘₐₓ and in the case of P_{E}_{_{—}}ₘᵢₙ>Pᵢₙ. Therefore, a period that the SOC_{P} reaches upper and lower limits can be shortened. As a result, a system operation rate can be improved in comparison with the first embodiment.

### Third Embodiment

A third embodiment will be described next.

An overall configuration of the third embodiment and a flowchart illustrating a calculation procedure for inverter power command values P_{A} and P_{B} are similar to those of the first embodiment illustrated in FIG. 1 and FIG. 2. The third embodiment differs from the first embodiment in that a calculation method for a first threshold value Tᵣ₁ and a second threshold value Tᵣ₂, which have been determined in step S302, is changed.

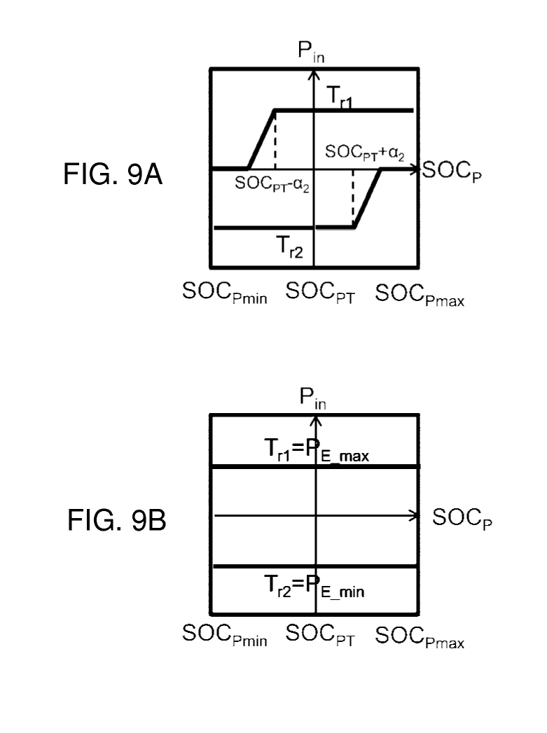

FIG. 9(a) is a correlation diagram in which the correlation, illustrated in FIG. 3(a) according to the first embodiment, between the SOC_{P} of the power type battery 106 and the first threshold value Tᵣ₁ and the second threshold value Tᵣ₂ is changed. In the third embodiment, when a SOC_{P} of a power type battery 106 is within a range of ±α₂ of a target SOC_{PT}, a first threshold value Tᵣ₁ and a second threshold value Tᵣ₂ are respectively P_{E}_{_{—}}ₘₐₓ and P_{E}_{_{—}}ₘᵢₙ.

As an example of a method for calculating the first threshold value Tᵣ₁ and the second threshold value Tᵣ₂, a method using a battery voltage V_{P} and a full charge capacity C_{P}_{_{—}}ₘₐₓ of the power type battery, a proportional constant S set based on a control cycle, and a constant α₂, in addition to the SOC_{P} of the power type battery 106, will be described. A formula in the case of SOC_{P}≧SOC_{PT+α}_{₂} is the formula (7) below. A formula in the case of SOC_{P}<SOC_{PT-α}_{₂} is the formula (8) below. A formula in the case of SOC_{PT-α}_{₂}≦SOC_{P}<SOC_{PT+α}_{₂} is the formula (9) below.

$$\begin{matrix}{T}_{r 2} = \frac{( ( {SOC}_{P} - {α}_{2} ) - {SOC}_{PT} )}{100} \times {C}_{P\_max} \times {V}_{P} \times S + {P}_{E\_min} \\ ( {T}_{r 2} = 0 in the case {T}_{r 2} \geq 0 ) & ( 7 ) \\ {T}_{r 1} = \frac{( {SOC}_{PT} - ( {SOC}_{P} + {α}_{2} ) )}{100} \times {C}_{P\_max} \times {V}_{P} \times S + {P}_{E\_max} \\ ( {T}_{r 1} = 0 in the case {T}_{r 1} < 0 ) & ( 8 ) \\ {T}_{r 1} = {P}_{E\_max} \\ {T}_{r 2} = {P}_{E\_min} & ( 9 )\end{matrix}$$

As with the first embodiment, the first threshold value satisfies Tᵣ₁=P_{E}_{_{—}}ₘₐₓ in the formula (7) and the second threshold value satisfies Tᵣ₂=P_{E}_{_{—}}ₘᵢₙ in the formula (8).

The constant α2 is, for example, around 5 to 10% since a SOC use width (ΔSOC) of a lithium ion battery for a hybrid vehicle, which is one of power type batteries, is usually designed to be around 10 to 20%.

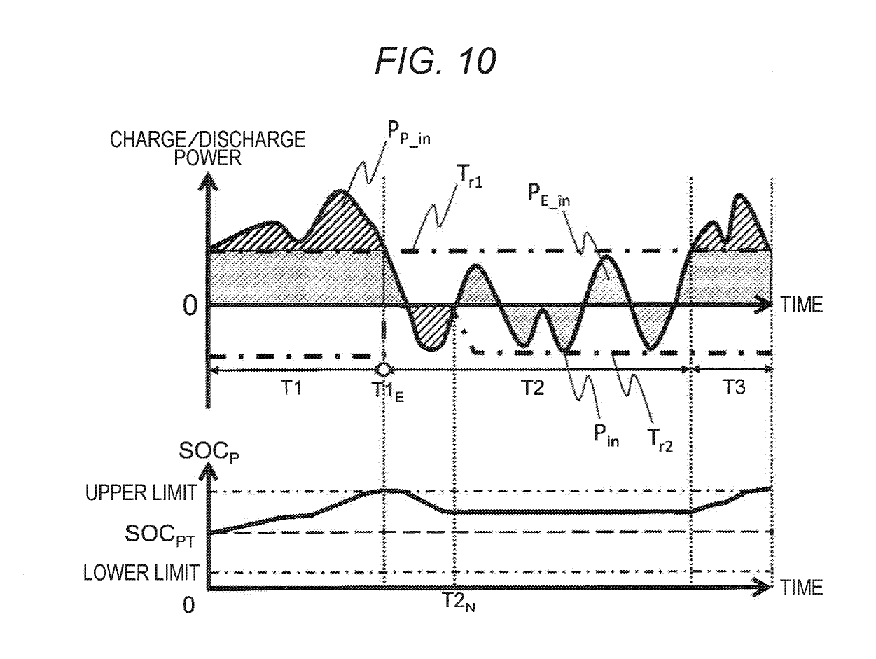

FIG. 10 illustrates a time change in charge/discharge power and a time change in the SOC_{P} of the power type battery in the case where a threshold value is changed by using a control according to the third embodiment. Charging and discharging by a capacity type battery 105 and charging and discharging by the power type battery 106 can be more freely changed in comparison with the first embodiment by changing a value of α₂ by changing a method for calculating a threshold value to the above-described calculation method. By using the above formula in the embodiment, discharging in sections from T_{1E} to T_{2N} described in FIG. 10 can be covered by the power type battery 106. According to FIG. 10, a frequency at which the SOC_{P} of the power type battery 106 comes close to a target value is reduced. Therefore, a period that the SOC_{P} reaches upper and lower limits becomes longer than that of the first embodiment. However, an integrated amount of a charge/discharge current I_{P}_{_{—}}ᵢₙ to be input and output to the power type battery 106 is lowered, and deterioration of the power type battery can be reduced.

### Fourth Embodiment

A fourth embodiment will be described next. The embodiment differs from the first embodiment in that an upper limit set value of a battery temperature is included in a determination flow.

An overall configuration of the fourth embodiment and a flowchart illustrating a procedure for calculating inverter power command values P_{A} and P_{B} are similar to those of the first embodiment illustrated in FIG. 1 and FIG. 2.

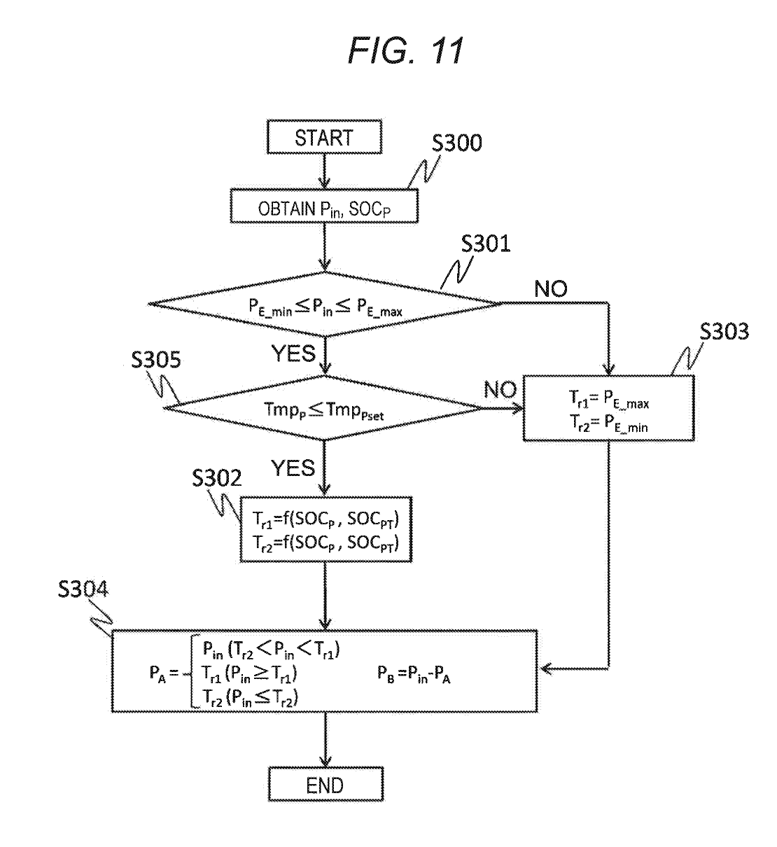

FIG. 11 is a flowchart illustrating a procedure for calculating the inverter power command values P_{A} and P_{B} of a battery combined controller 104 according to the fourth embodiment. In the fourth embodiment, when it is determined in step S301 that charge/discharge power Pᵢₙ is equal to or less than maximum charge power P_{E}_{_{—}}ₘₐₓ or equal to or larger than maximum discharge power P_{E}_{_{—}}ₘᵢₙ, a procedure proceeds to step S305. In step S305, it is determined whether a battery temperature Tmp_{P} of a power type battery 106 is equal to or less than an upper limit set value of a battery temperature Tmp_{Plim}. When the battery temperature Tmp_{P} of the power type battery 106 is equal to or less than a battery temperature set value Tmp_{Pset}, a procedure proceeds to S302; otherwise, the procedure proceeds to S303.

Adding the battery temperature determination prevents the power type battery 106 from being incapable of charged/discharged when reaching a temperature upper limit. As a result, a system operation rate can be improved.

Hereinafter, characteristics of the present invention according to the first to fourth embodiments, which have been described above, will be described.

One of the embodiments of the present invention is a battery combined system in which a capacity type battery and a power type battery having a higher output/capacity value than that of the capacity type battery are connected in parallel. A threshold value to distribute charge/discharge power to the power type battery or the capacity type battery is changed in a case where the charge/discharge power is equal to or less than maximum charge power and equal to or larger than maximum discharge power of the capacity type battery.

Due to such configuration, a power type battery can be charged or discharged even if the charge/discharge power is equal to or less than maximum charge power and equal to or larger than maximum discharge power of the capacity type battery. Therefore, power can be flexibly distributed to the power type battery and the capacity type battery, and a frequency at which an SOC of the power type battery reaches an upper limit or a lower limit can be reduced.

Also, a battery combined system avoiding a situation where the power type battery cannot be charged and discharged can be provided.

Also, in one of the embodiments of the present invention, the threshold values (Tᵣ₁ and Tᵣ₂) are set based on a state of charge (SOC) of the power type battery.

The threshold values (Tᵣ₁ and Tᵣ₂) are determined based on the SOC of the power type battery, not based on an SOC of a capacity type battery. Therefore, the SOC of the power type battery, of which capacity is easily fully charged, can be easily adjusted. Accordingly, a frequency at which the SOC of the power type battery reaches an upper limit and a lower limit can be reduced.

Also, one of the embodiments of the present invention enables to prevent, by setting the threshold values (Tᵣ₁ and Tᵣ₂) further based on a target SOC of the power type battery, the SOC of the power type battery from deviating from a predetermined SOC.

Also, in one of the embodiments of the present invention, the threshold values (Tᵣ₁ and Tᵣ₂) are maximum charge power of a capacity type battery in the case where charge/discharge power is larger than the maximum charge power of the capacity type battery, and the threshold values (Tᵣ₁ and Tᵣ₂) are maximum discharge power of the capacity type battery in the case where the charge/discharge power is smaller than the maximum discharge power of the capacity type battery.

In this manner, power which cannot be absorbed by a capacity type battery can be certainly absorbed by a power type battery.

Also, in one of the embodiments of the present invention, the threshold values (Tᵣ₁ and Tᵣ₂) are set based on a value adding a predetermined constant to a target SOC or subtracting the predetermined constant from the target SOC.

In a case other than the case where charge/discharge power is equal to or less than maximum charge power and equal to or larger than maximum discharge power of the capacity type battery, charging and discharging can be covered by a power type battery. Therefore, in comparison with the method according to the first embodiment, a charge/discharge current amount of the power type battery can be divided, and deterioration of the power type battery by such as an increase in temperature can be suppressed.

Also, in one of the embodiments of the present invention, ½ of a SOC use width of a power type battery is added to or subtracted from a target SOC.

With such configuration, a charge/discharge current amount of the power type battery can be sufficiently divided, and deterioration of the power type battery can be further suppressed.

Also, in one of the embodiments of the present invention, the threshold values are set based on an upper limit SOC or a lower limit SOC of a power type battery in the case where charge/discharge power is larger than maximum charge power of the capacity type battery or in the case where the charge/discharge power is smaller than maximum discharge power of the capacity type battery.

In this manner, by using the SOC having a certain width (SOC_{Pmin} to SOC_{Pmax}) in calculation of the threshold values (Tᵣ₁ and Tᵣ₂), a frequency at which an SOC of a power type battery can come close to a target value increases in comparison with the method according to the first embodiment. As a result, an operation rate of a battery combined system can be improved by avoiding a situation where a power type battery cannot be charged and discharged, in comparison with the first embodiment.

Also, in one of the embodiments of the present invention, an upper limit SOC (SOC_{Pmax}) of a power type battery is a value adding a predetermined constant to the target SOC, and a lower limit SOC (SOC_{Pmin}) of the power type battery is a value subtracting the predetermined constant form the target SOC.

With such configuration, a frequency at which the SOC of the power type battery far deviates from the target SOC is reduced, and a battery combined system capable of stable driving can be provided.

Also, in one of the embodiments of the present invention, the upper limit SOC (SOC_{Pmax}) and the lower limit SOC (SOC_{Pmin}) are 5 to 10% higher or lower than the target SOC.

The configuration can prevent a lifetime of the power type battery from being shortened by a significant increase in a use ratio of the power type battery.

Also, in one of the embodiments of the present invention, the threshold values are maximum charge power or a maximum discharge power of the capacity type battery in a case where a battery temperature of the power type battery is equal to or larger than an upper limit temperature.

The configuration can prevent a situation where a power type battery cannot be charged or discharged when the battery temperature of the power type battery reaches the upper limit. As a result, a system operation rate can be improved.

The embodiments according to the present invention have been described above. However, the present invention is not limited to the embodiments, and various design changes are possible within the scope of a spirit of the present invention described in CLAIMS. For example, the above embodiments are described in detail for easier understanding of the present invention, and all of the described configurations are not necessarily provided. Also, a part of the configuration of one embodiment can be switched to a configuration of other embodiment, and a configuration of other embodiment can also be added to the configuration of the one embodiment. Furthermore, in a part of a configuration of each embodiment, other configuration can be added, deleted, or switched.

### REFERENCE SIGNS LIST

100 battery combined system
101 power generation element
102 power system
103 power measuring device
104 battery combined controller
105 capacity type battery
106 power type battery
107A, 107B inverter
108A, 108B DC line
109 AC line

1. A battery combined system, in which a capacity type battery and a power type battery having a higher output/capacity value than that of the capacity type battery are connected in parallel,
wherein, a threshold value to distribute charge/discharge power to the power type battery or the capacity type battery is changed in a case where the charge/discharge power is equal to or less than maximum charge power and equal to or larger than maximum discharge power of the capacity type battery.

2. The battery combined system according to claim 1, wherein the threshold value is set based on a state of charge (SOC) of the power type battery.

3. The battery combined system according to claim 2, wherein the threshold value is set further based on a target SOC of the power type battery.

4. The battery combined system according to claim 3, wherein
the threshold value is maximum charge power of the capacity type battery in a case where the charge/discharge power is larger than the maximum charge power of the capacity type battery, and
the threshold value is maximum discharge power of the capacity type battery in a case where the charge/discharge power is smaller than the maximum discharge power of the capacity type battery.

5. The battery combined system according to claim 3, wherein the threshold value is set based on a value obtained by adding a predetermined constant to the target SOC or by subtracting the predetermined constant from the target SOC.

6. The battery combined system according to claim 5, wherein the predetermined constant is ½ of a SOC use width of the power type battery.

7. The battery combined system according to claim 3, wherein the threshold value is set based on an upper limit SOC of the power type battery or a lower limit SOC of the power type battery, in a case where the charge/discharge power is larger than maximum charge power of the capacity type battery or in a case where the charge/discharge power is smaller than maximum discharge power of the capacity type battery.

8. The battery combined system according to claim 7, wherein
the upper limit SOC is a value obtained by adding a predetermined constant to the target SOC, and
the lower limit SOC is a value obtained by subtracting the predetermined constant from the target SOC.

9. The battery combined system according to claim 8, wherein the predetermined constant is 5 to 10%.

10. The battery combined system according to claim 3, wherein the threshold value is maximum charge power of the capacity type battery or the threshold value is maximum discharge power of the capacity type battery, in a case where a battery temperature of the power type battery is equal to or larger than an upper limit temperature.
